(19) United States
(12) Patent Application Publication
(10) Pub. No.: US 2006/0012682 A1
(43) Pub. Date: Jan. 19, 2006

(54) Dynamic monitor system

(75) Inventor: Rehn-Lieh Lin, Chutung Town (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: WINBOND ELECTRONICS CORPORATION, Hsinchu (TW)

(21) Appl. No.: 10/891,006

(22) Filed: Jul. 15, 2004

(51) Int. Cl. H04N 5/225; H04N 5/232; H04N 5/222

(52) U.S. Cl. 348/207.1; 348/211.11; 348/333.05

(57) ABSTRACT

Monitor cameras are connected to a network and a user uses a browser to read in the images on these cameras via a network. Images captured by the cameras are displayed on the display area of the browser, and the user is allowed to add or delete any assigned video displays via an interface provided by a web page in the browser. While the user adds or deletes the video displays, the allocation of the display area of the browser is dynamically adjusted, so that the user can monitor a plurality of sites dynamically at the same time conveniently and flexibly.

### FIELD OF THE INVENTION

The present invention relates to a dynamic monitor system, and more particularly to the remote monitor system that can access multiple images via a network.

### BACKGROUND OF THE INVENTION

In order to control the situation of a bigger area under limited manpower, various monitor systems have been developed. These monitor systems are used in factories, parking lots, multi-story buildings and communities, etc. for performing the job of real time or taped security monitoring.

Referring to FIG. 1, FIG. 1 is an allocation diagram of a conventional monitor system 10. The monitor system 10 has a plurality of cameras 1011, 1013, 1015 and 1017 used for capturing images on different monitored areas. After the cameras 1011, 1013, 1015 and 1017 are connected to a signal-processing apparatus 103 via a special line 107, the monitored images are displayed on several areas of a monitor 105, such as the monitored areas a, b, c and d shown in FIG. 1.

The conventional monitor system 10 uses a special signal-processing apparatus 103 that is not easy to be adjusted. For example, although a watcher can monitor four areas a, b, c and d at the same time as shown in FIG. 1, yet each of the monitored areas a, b, c and d merely occupies one fourth of the total display area of the monitor 105. In order to enlarge some specific areas or temporarily monitor the areas a and c, some complicated settings generally have to be made. Besides, due to the feature of the special line 107, the addition or removal of another camera usually has to be involved in rearranging the wirings, and the wiring rearrangement is a very tedious job for the watcher.

Further, due to the feature of the special line 107, with the use of the conventional monitor system 10, the watcher usually has to go to the site at which the signal-processing apparatus 103 is located for watching the monitor 105. If there are several watchers desiring to watch the monitored images at various places, the wiring rearrangement has to be involved, which is not only tedious but also expensive in cost.

Another type of monitor system is developed on the top of the Internet technology. In this type of monitor system, the monitored images captured by the cameras are transmitted to a watcher's computer, and the watcher reads in the monitored images via a special client program or a common web browser.

The special client program can provide various flexible functions, but the watcher has to install the special client program for reading in the monitored images, i.e. the watcher is restricted by his computer, and cannot freely move to other places.

The advantage of using the web browser mainly resides in that the watcher does not need to install any special client program in advance, and still can read in the monitored images at any time via any computer connected to a network, i.e. the watcher does not need to rely on the computer having the special client program, and is able to read in the monitored images via a computer having a web browser.

However, among the current applications of using the web browser to read in the monitored images, most of them can only display one single, image, and does not support the display of multiple images and the function of dynamically adding images. If having to monitor multiple images, a user has to bring up multiple browsers simultaneously on a screen. However, the user has to adjust the display of each browser respectively, and quite a lot of inconvenience is caused.

Overall, the conventional monitor systems mainly can monitor a fixed number of images, and are not allowed to display an arbitrary number of images. Meanwhile, the resolutions of the monitored image displays are all the same. However, those restrictions have restricted a watcher's actions with respect to various points of view, thus resulting in inconvenience of different levels of degree.

### SUMMARY OF THE INVENTION

Therefore, an object of the present invention is to provide a dynamic monitor system, thereby providing a flexible and convenient tool for a user to monitor a plurality of areas at the same time.

According to an embodiment of the present invention, a dynamic monitor system reads in a plurality of images from a plurality of image-capturing tools, wherein the image-capturing tools are connected to a network. The dynamic monitor system performs the following actions via instruction codes.

At first, an input interface is shown on a browser, and a user enters a website address via the input interface, wherein the website address is directed to one of the image-capturing tools. In accordance with the website address, a monitored image is retrieved from the corresponding image-capturing tool. Meanwhile, the monitored image is displayed on a display area of the browser. If the display area has already shown another monitored image captured by another image-capturing tool, then the display arrangement of the display area is dynamically adjusted for the monitored images, thereby allowing a user to read in the monitored images to the display area.

Further, the user also can remove several monitored images; or adjust the resolution or the compression quality etc. for each of the monitored images. The instruction codes provided for performing the aforementioned functions can be stored in one or more web pages. The user first establishes a connection to the web page(s) via a browser to obtain the instruction codes for further performing the aforementioned functions. Once the user obtains the instruction codes, no more browsers need to be activated, and the user can perform various settings and operations onto the monitored images with one single browser. The instruction codes can be implemented via JavaScript combined with the components such as ActiveX, etc.

Since the tool adopted in the present invention is a browser, the user may perform the multiple-areas monitoring job with any computer that is connected to the network and has a browser. Since the multiple-areas monitoring job can be done by activating one single browser, a lot of border space occupied by activating multiple browsers can be saved. Further, since the display areas opened for showing multiple images are managed by a unified interface, the entire monitoring job can be executed more effectively, thus avoiding missing important images while the display areas are adjusted in size or switched to one another. Further, the entire monitor system can be dynamically adjusted, and thus the user is allowed to open different monitored display areas in accordance with different time requirements. For example, the critical areas to be monitored are different for office hours and after-hours, and yet the monitored areas can be easily adjusted for the system of the present invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an allocation diagram of a conventional monitor system;

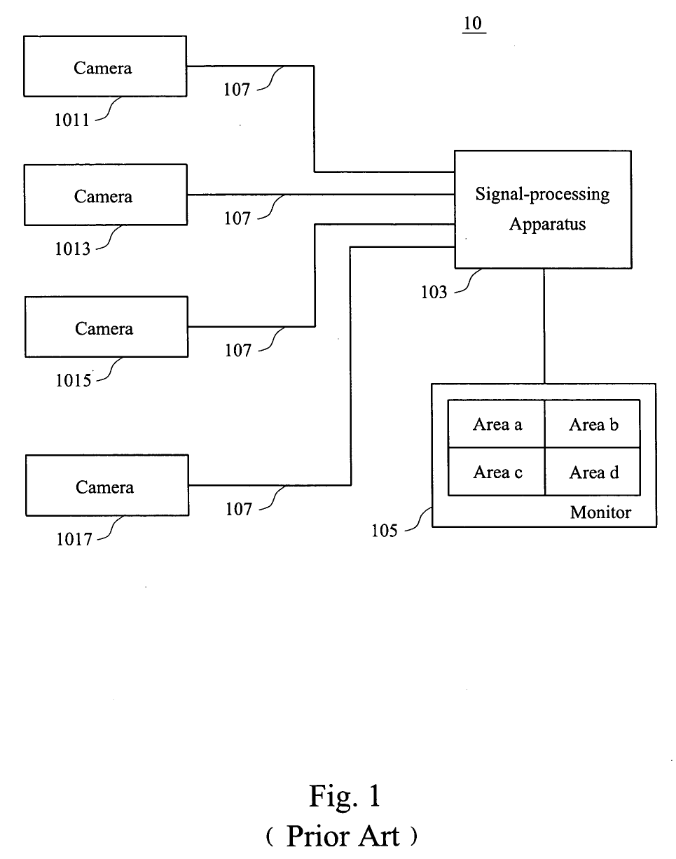

FIG. 2 is a diagram showing the environmental allocation of an embodiment of the present invention;

FIG. 3 is a schematic block diagram showing the embodiment of the present invention;

FIG. 4 is a diagram showing the display allocation of the browser used in the embodiment of the present invention;

FIG. 5 is a schematic diagram showing the flow chart of the embodiment of the present invention;

FIG. 6(a) is a schematic diagram showing an operation condition of the embodiment of the present invention;

FIG. 6(b) is a schematic diagram showing another operation condition of the embodiment of the present invention;

FIG. 6(c) is a schematic diagram showing another operation condition of the embodiment of the present invention; and

FIG. 6(d) is a schematic diagram showing another operation condition of the embodiment of the present invention.

### DETAILED DESCRIPTION OF THE PREFERRED EMBODIMENT

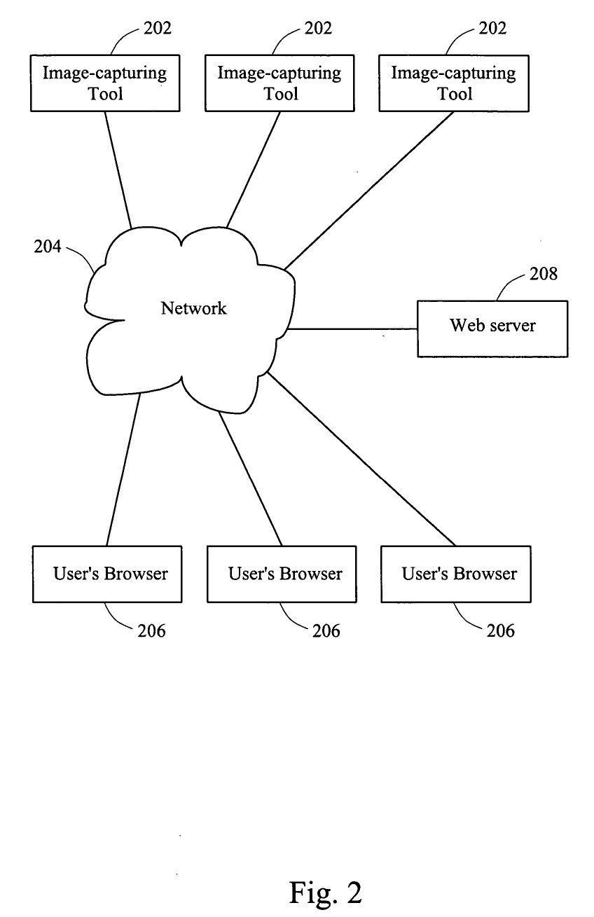

Referring to FIG. 2, FIG. 2 is a diagram showing the environmental allocation suitable for use in an embodiment of the present invention.

A plurality of image-capturing tools 202 are connected to a network 204, and the image-capturing tools 202 can be webcams having the function of web server, or any computers or electronic apparatus equipped with cameras. The image-capturing tools 202 are installed on each of the areas to be monitored. The network 204 herein can be any kind of local area networks, such as Ethernet, telecommunication network or Internet.

Meanwhile, what is also connected to the network 204 can be a browser 206 belonging to a user. The user may use any kind of computer or electronic apparatus that can execute the browser to establish a connection to the network and can retrieve network data via the browser. Besides, the network 204 is also connected to one or more web servers 208 for providing the contents of web page or web page programs. Under this architecture, theoretically, any arbitrary number of user browsers 206 and image-capturing tools 202 can be dynamically implemented.

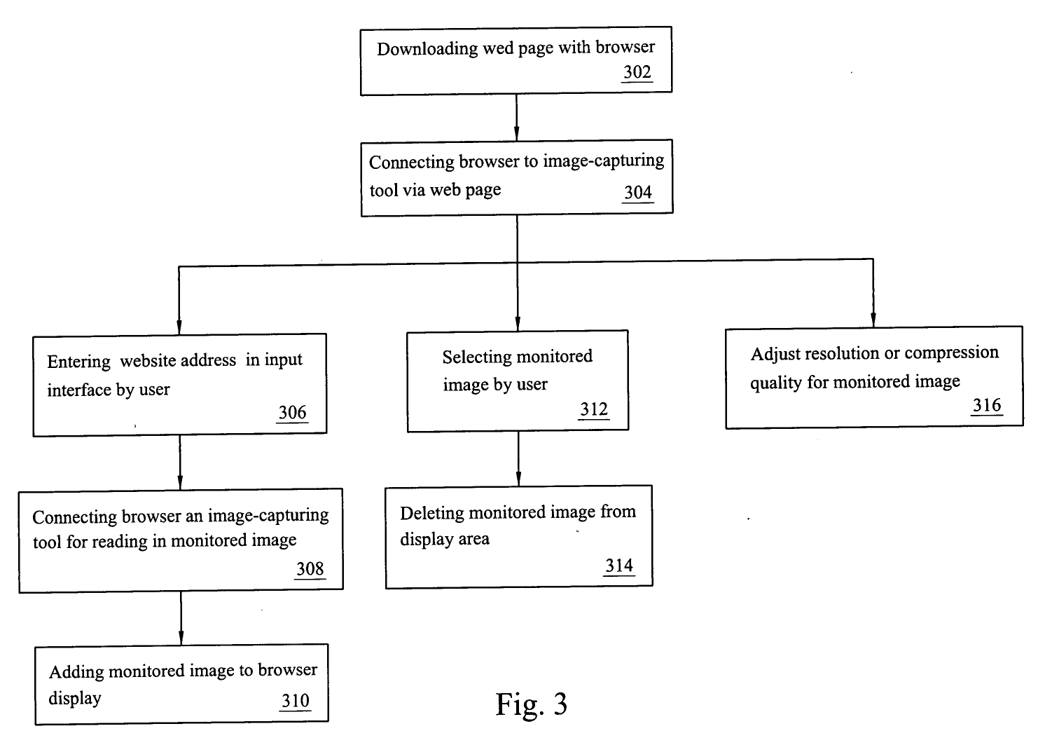

Referring to FIG. 3, FIG. 3 is a schematic block diagram showing how the user read in the monitored images captured by the image-capturing tools 202 by using the embodiment of the present invention.

At first, the user downloads a web page with a browser (step 302), and the web page contains a plurality of instruction codes. The instruction codes are the programs of HTML mixed with JavaScript and VBScript, etc., and also can contain program codes used for calling Microsoft DCOM objects so as to perform the following functions. After downloading the instruction codes, the browser 206 presents to the user an operation interface and a display area for monitoring use in accordance with the instruction codes.

The web page can be installed on the web server 208, and the user may assign a website address (such as domain name or IP address) of the web server 208 via the network 204, so as to retrieve the web page. Certainly, the web page also can be stored in the user's computer or electronic apparatus, and alternatively the web page can be stored in the image-capturing tool 202, such as a webcam. For example, when the image-capturing tool 202 is the combination of a webcam and a server, the web page can be stored in the server. On the other hand, if the image-capturing tool 202 itself has the function of web server, the web page can be certainly stored in the memory device of the image-capturing tool 202, such RAM, flash memory, hard disk, or floppy disk. Besides, the substantial contents of the web page also can be stored in a web server other than the image-capturing tool 202, so that the service is redirected to the web server for the user's browser 206 to retrieve the contents of the web page while the user is connected to the image-capturing tool 202.

Thereafter, the user's browser 206 starts receiving the monitored image captured by the image-capturing tool via the instruction codes in the aforementioned web page (step 304), and the instruction codes comprising a protocol such as DCOM objects, JAVAapplet implemented for image transmission.

When being downloaded, the monitored image is shown on the display area of the user's browser 206. Further, the browser 206 also provides the user an input interface in accordance with the instruction codes in the aforementioned web page for entering the website address (such as domain name or IP address) of another image-capturing tool 202.

When the user enters a website address of a certain image-capturing tool 202 in the interface (step 306), the browser 206 starts searching for the image-capturing tool 202 in the network in accordance with the website address entered, and reads in another monitored image from the image-capturing tool 202 (step 308). The (another) monitored image is automatically added to the original display area after being read (step 310).

The step of adding a new monitored image to the original display area is performed via the instruction codes in the web page, and thus, while the new monitored image is added, the screen allocation can be adjusted to make a proper size of the display area for showing these monitored images.

Besides being able to dynamically add new monitored images, the system of the present invention also can dynamically delete the designated monitored image. Similarly, the user also can first select a monitored image in accordance with the interface provided by the instruction codes in the web page via the browser (step 312). Thereafter, the browser deletes the selected monitored image from the display area in accordance with the instruction codes in the web page (step 314), and if necessary, adjusts the screen allocation of the display area automatically and dynamically.

With reference to the embodiment, the user also can adjust the settings of the resolution and compression quality for respective images (step 316). When the respective images are added to the display area in the form of object, the respective images are processed with different objects, such as ActiveX or DCOM objects, so that the respective images can have different parameter values. Therefore, as long as one interface is provided to the user, those parameter values can be adjusted and set respectively.

In order to explain the features of the present invention more clearly, an embodiment is used in the below for further explanation.

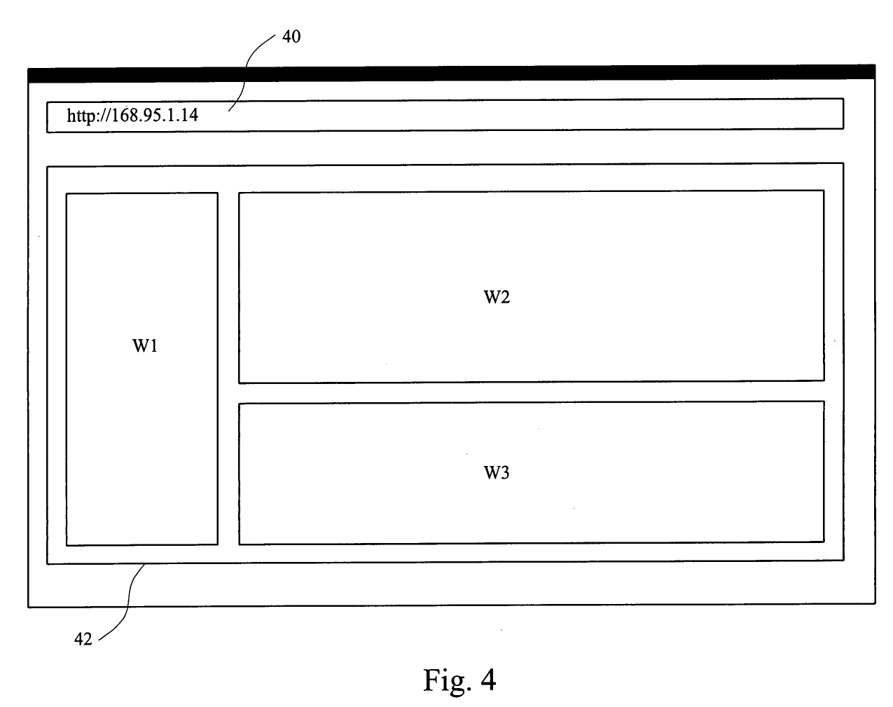

FIG. 4 is a diagram showing the display allocation of the browser used in this embodiment. Besides a website address bar 40 provided for inputting a website address, a browser window 42 is mainly divided into three window portions w1, w2, and w3 via the instruction codes in a browser. The window portion w1 is provided for the user to perform normal settings, and the window portion w2 is provided for displaying one or more monitored images, and the window portion w3 is provided for the user to enter the website address of a new image-capturing tool.

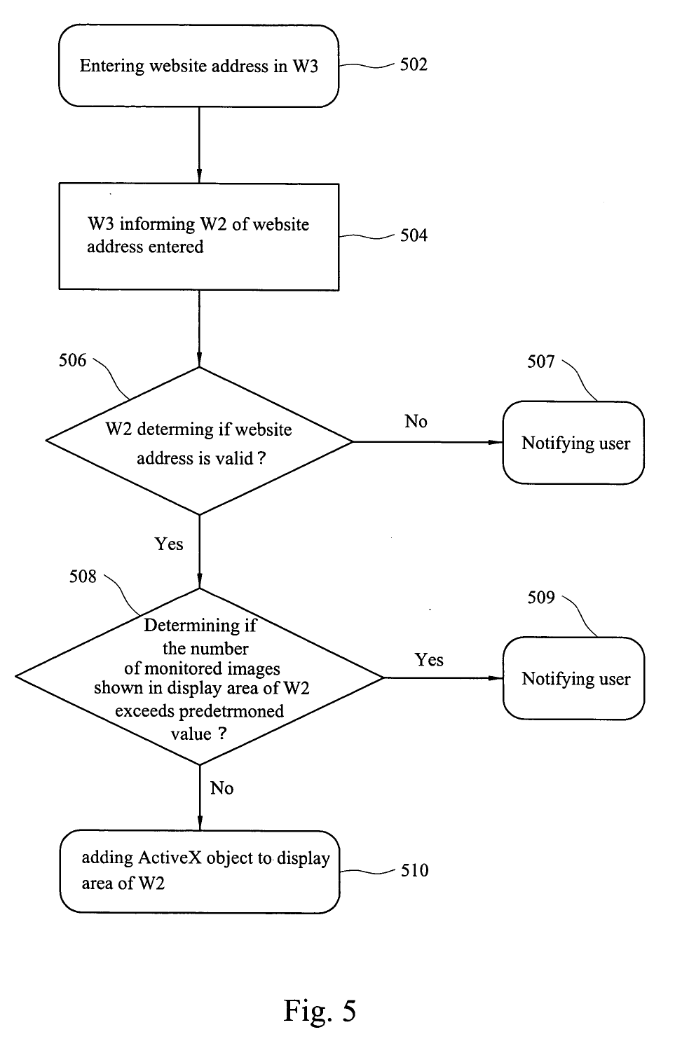

FIG. 5 is a flow chart of this embodiment. The flow chart can be implemented with JavaScript or VBScript combined with the object Active X. Certainly, the methods of JAVA-applet or others executed in a browser are all applicable to the scope of the present invention.

At first, a user enters a website address of an image-capturing tool in the window portion w3 (step 502). The window portions w2 and w3 both are attached to a parent window of upper level, and thus the window portion w3 informs the window portion w2 of the website address (such as domain name or IP address) entered by the user (step 504). Then, the instruction code in the window portion w2 determines if the website address is valid and is corresponding to an image-capturing tool in operation (step 506). If the website address is invalid, then the user is notified about this situation (step 507).

If the website address is valid, the instruction codes of the window portion w2 determines if the number of monitored images shown in the display area thereof exceeds a predetermined value (step 508). If the number of monitored images exceeds the predetermined value, then the user is notified about this situation (step 509).

If no problems occur, then the window portion w2 establishes and adds a new ActiveX or DCOM object to the display area thereof so as to receive and monitor the monitored images (step 510). For example, the window portion w2 executes the following instruction code:

<OBJECT ID=oCamCtl

CODEBASE=“WinWebPush.cab#version=1,0,0,9”
CLASSID=“CLSID:7876E4A5-7BB7-4002-B08F-C960A1ED4231”>

</OBJECT>

As to this ActiveX object, it is written to communication with the image-capturing tool so as to receive and illustrate the monitored image on the predetermined area. Those who are skilled in the art can understand the fabrication of this ActiveX object with reference to ordinary computer programming books, so that the fabrication of this ActiveX object will not be described herein.

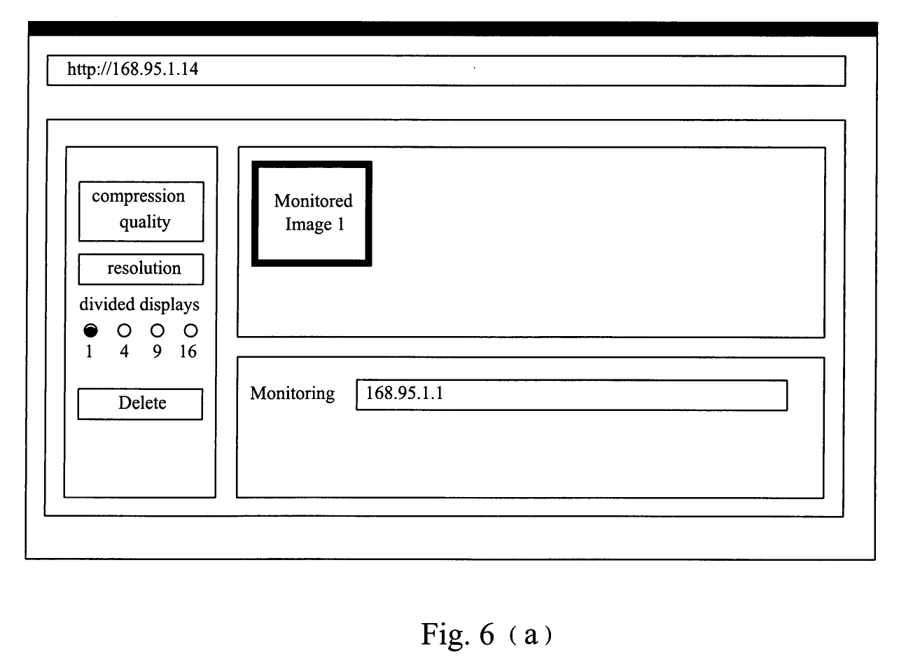

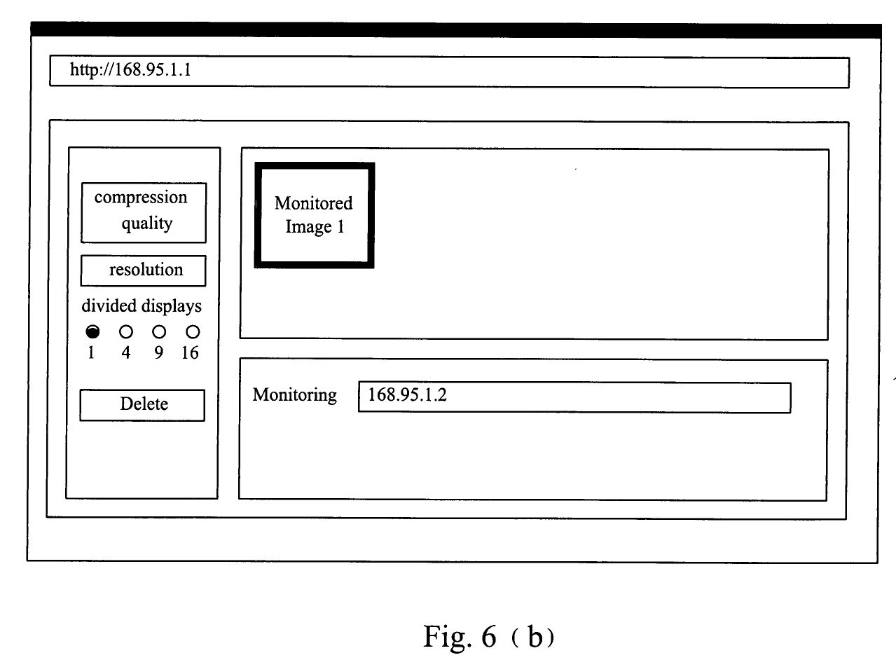

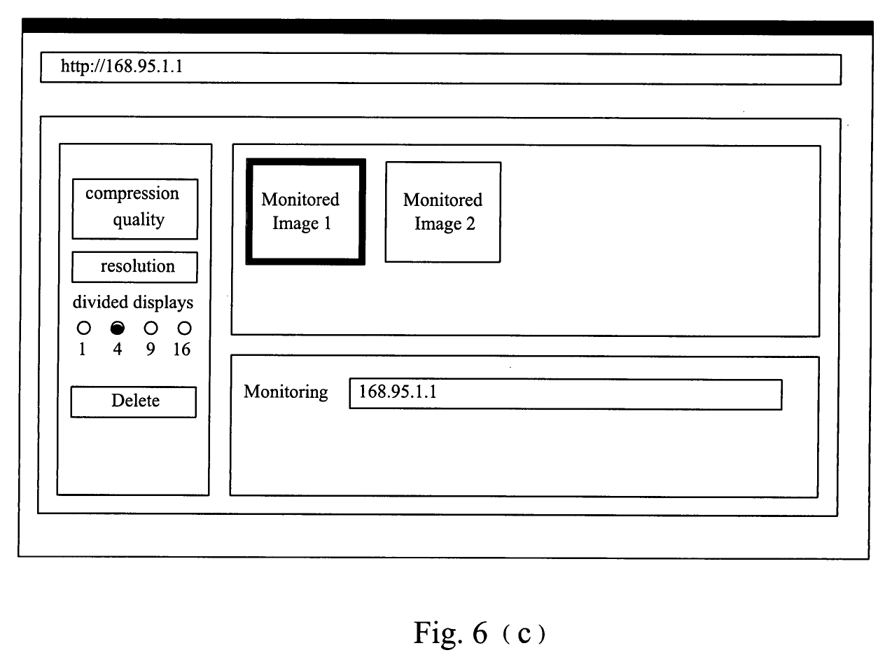

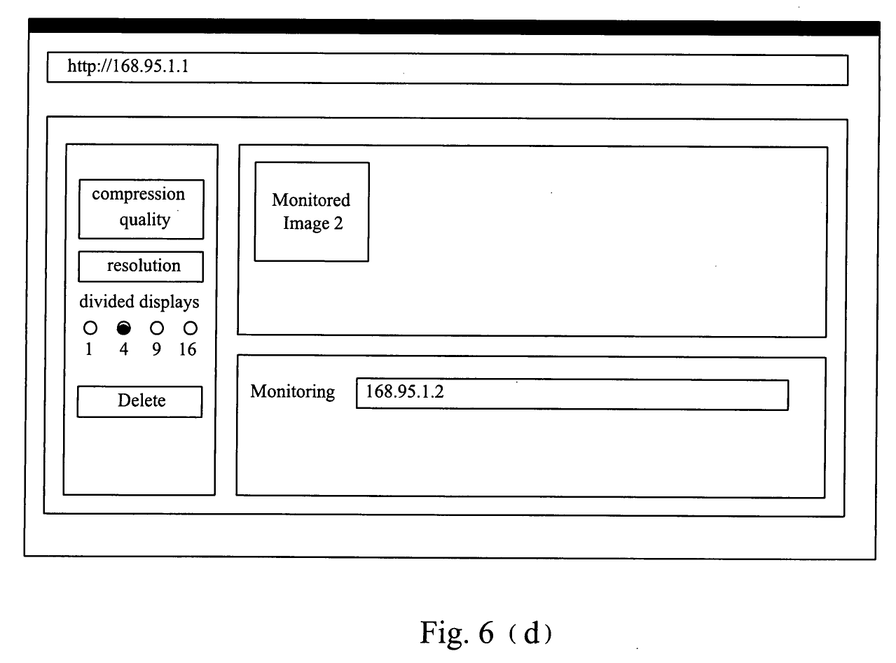

Thereafter, referring to FIG. 6(a) to FIG. 6(d), the practical application of the aforementioned embodiment can be explained with these four figures.

At first, such as shown in FIG. 6(a), a basic operation menu presented to a user through a browser can be seen in accordance with the instruction codes in the aforementioned web page. On the left side of the operation menu, i.e. the window portion w1, is provided for a user to set the resolution and compression quality of a certain selected image monitored; and the number of areas into which the entire display area is divided into such as 1, 4, 9 and 16 areas for respectively displaying 1, 4, 9 and 16 monitored images. This window portion also provides a “delete” button for the user to delete the designated monitored image.

The monitored image is shown on the window portion w2, and the window portion w3 provides the user an interface of entering a website address.

FIG. 6(b) shows the situation when a user enters a website address (168.93.1.2) in the interface of the window portion w3. FIG. 6(c) shows the situation after a monitored image is read in and shown on the display area. At this time, the user selects the monitored image 1 and presses the delete button so as to delete the monitored image 1, and thus the display shown in FIG. 6(d) is obtained.

While a monitored image is added or deleted, the window portion w2 automatically rearranges the display allocation, so that the user does not have to move a mouse to allocate the location and size of each monitored image.

Hence, the present invention actually provides the user an efficient and flexible system that can dynamically monitor multiple image-capturing tools.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A dynamic adjustable image-monitoring system used for read in a plurality of monitored images captured by a plurality of image-capturing tools, wherein said image-capturing tools are connected to a network, said system comprising:
a first instruction code provided for showing an input interface on a browser, wherein a user enters a website address via said input interface, and said website address is directed to one of said image-capturing tools;
a second instruction code provided for reading in one image of said monitored images from said one of said image-capturing tools in accordance with said website address; and
a third instruction code provided for displaying said one image on a display area of said browser, wherein, if said display area has already shown another image of said monitored images captured by another of said image-capturing tools, the display arrangement of said display area is dynamically adjusted for said monitored images, thereby allowing a user to read in said monitored images to said display area.

2. The system of claim 1, further comprising:
a fourth instruction code provided for said user to delete said one image from said display area.

3. The system of claim 1, further comprising:
a fifth instruction code provided for said user to set the resolution of each of said monitored images.

4. The system of claim 1, further comprising:
a sixth instruction code provided for said user to set the compression quality of each of said monitored images.

5. The system of claim 1, wherein said first instruction code, said second instruction code and said third instruction code contain JavaScript codes.

6. The system of claim 1, wherein said first instruction code, said second instruction code and said third instruction code contain VBScript codes.

7. The system of claim 1, wherein said first instruction code, said second instruction code and said third instruction code contain codes calling Microsoft DCOM objects

8. The system of claim 1, wherein each of said image-capturing tools is a webcam, and said webcam sends back said first instruction code, said second instruction code and said third instruction code responding to said browser.

9. The system of claim 1, wherein each of said image-capturing tools is composed of a camera and a server that is connected to said camera.

10. The system of claim 9, wherein said first instruction code, said second instruction code and said third instruction code are stored in said server, and said browser downloads and executes said first instruction code, said second instruction code and said third instruction code when said user uses said browser to establish connection to said server.

11. A method for managing monitored images with a browser, said method comprising:
providing an input interface on a browser for a user to enter a website address, wherein said website address is directed to one image-capturing tool;
reading in one monitored image of said monitored images from said one image-capturing tool in accordance with said website address;
displaying said one monitored image on a display area of said browser; and
if said display area has already shown another monitored image of said monitored images captured by another image-capturing tool, the display arrangement of said display area is dynamically adjusted for showing said monitored image.

12. The method of claim 11, further comprising:
allowing said user to delete said one monitored image from said display area.

13. The method of claim 12, further comprising:
dynamically adjusting the display arrangement of said display area after said one monitored image is deleted.

14. The method of claim 11, further comprising:
allowing said user to set the resolution of each of said monitored images.

15. The method of claim 11, further comprising:
allowing said user to set the compression quality of each of said monitored images.
